(19) United States
(12) Patent Application Publication
(10) Pub. No.: US 2022/0126792 A1
(43) Pub. Date: Apr. 28, 2022

(54) SENSING SYSTEM FOR VEHICLE AND VEHICLE

(71) Applicant: KOITO MANUFACTURING CO., LTD., Tokyo (JP)

(72) Inventors: Yusuke TOTSUKA, Shizuoka-shi, Shizuoka (JP); Yuta MARUYAMA, Shizuoka-shi, Shizuoka (JP); Takanori NAMBA, Shizuoka-shi, Shizuoka (JP)

(73) Assignee: KOITO MANUFACTURING CO., LTD., Tokyo (JP)

(21) Appl. No.: 17/430,425

(22) PCT Filed: Jan. 20, 2020
(86) PCT No.: PCT/JP2020/001744

§ 371 Date: Aug. 12, 2021

(30) Foreign Application Priority Data
Feb. 18, 2019 (JP) 2019-026548

(51) Int. Cl. B60S 1/60; G01S 7/497

(52) U.S. Cl. CPC B60S 1/60; G01S 2007/4977; G01S 7/497

(57) ABSTRACT

A sensing system is configured to detect dirt adhering to an outer cover of a vehicle lighting device mounted on a vehicle. The sensing system is provided with: a LiDAR unit disposed in a space formed by the housing and outer cover of the vehicle lighting device, and configured to acquire point cloud data indicating a surrounding environment of the vehicle; a lighting device cleaner configured to remove dirt adhering to the outer cover; and a lighting device cleaner controller configured to acquire reflected light intensity information relating to the intensities of a plurality of reflected light reflected by a road surface after being emitted from the LiDAR unit, determine, on the basis of the acquired reflected light intensity information, whether or not dirt is adhering to the outer cover, and drive the lighting device cleaner in accordance with a determination that dirt is adhering to the outer cover.

### TECHNICAL FIELD

The present disclosure relates to a sensing system for a vehicle and a vehicle.

### BACKGROUND ART

Currently, a research on an automatic driving technique of an automobile has been actively conducted in various countries, and legislation for allowing a vehicle (hereinafter, the “vehicle” refers to an automobile) to travel on a public road in an automatic driving mode has been studied in various countries. Here, a vehicle system automatically controls traveling of the vehicle in the automatic driving mode. Specifically, in the automatic driving mode, the vehicle system automatically executes at least one of steering control (control of an advancing direction of the vehicle), brake control, and accelerator control (control of braking, and acceleration or deceleration of the vehicle) based on information (surrounding environment information) that indicates a surrounding environment of the vehicle and is acquired from a sensor such as a camera or a radar (for example, a laser radar or a millimeter wave radar). On the other hand, in a manual driving mode to be described below, a driver controls traveling of the vehicle, as is cases of many related-art vehicles. Specifically, in the manual driving mode, the traveling of the vehicle is controlled according to an operation (a steering operation, a brake operation, and an accelerator operation) of the driver, and the vehicle system does not automatically execute the steering control, the brake control, and the accelerator control. A vehicle driving mode is not a concept that exists only in a part of vehicles, but a concept that exists in all vehicles including the related-art vehicles that do not have an automatic driving function, and the vehicle driving mode is classified according to, for example, a vehicle control method.

Therefore, it is expected in the future that a vehicle traveling in an automatic driving mode (hereinafter, referred to as an “automatic driving vehicle” as appropriate) and a vehicle traveling in a manual driving mode (hereinafter, referred to as a “manual driving vehicle” as appropriate) coexist on a public road.

As an example of the automatic driving technique, Patent Literature 1 discloses an automatic following travel system for a following vehicle to automatically follow a preceding vehicle. In the automatic following travel system, each of the preceding vehicle and the following vehicle includes a lighting system. Character information for preventing other vehicles from cutting in between the preceding vehicle and the following vehicle is displayed on the lighting system of the preceding vehicle, and character information indicating that the following vehicle automatically follows the preceding vehicle is displayed on the lighting system of the following vehicle.
Patent Literature 1: JP H9-277887 A

### SUMMARY OF INVENTION

With the development of the automatic driving technique, it is necessary to dramatically increase detection accuracy of a surrounding environment of the vehicle. In this regard, mounting a plurality of different types of sensors (for example, a camera, a LiDAR unit, a millimeter wave radar, and the like) on a vehicle is currently being studied. For example, it is considered to provide a plurality of sensors at each of four corners of the vehicle. Specifically, it is considered to mount a LiDAR unit, a camera, and a millimeter wave radar on each of four vehicle lamps provided at the four corners of the vehicle.

The LiDAR unit provided in the vehicle lamp acquires point group data indicating a surrounding environment of the vehicle through a transparent outer cover. Similarly, the camera provided in the vehicle lamp acquires image data indicating the surrounding environment of the vehicle through the transparent outer cover. Therefore, when dirt adheres to the outer cover of the vehicle lamp, there is a risk that the surrounding environment of the vehicle cannot be accurately specified based on the point group data of the LiDAR unit and/or the image data of the camera due to dirt (rain, snow, mud, or the like) adhering to the outer cover. As described above, when a sensor such as the LiDAR unit or the camera is provided in the vehicle lamp, it is necessary to study a method for detecting dirt that adheres to the outer cover and adversely affects the detection accuracy of the sensor.

An object of the present disclosure is to provide a sensing system for a vehicle and a vehicle that are capable of preventing a decrease in detection accuracy of a sensor provided in a vehicle lamp.

According to an aspect of the present disclosure, there is provided a sensing system for a vehicle configured to detect dirt adhering to an outer cover of a vehicle lamp provided in a vehicle. The sensing system for a vehicle includes: a LiDAR unit that is provided in a space defined by a housing and the outer cover of the vehicle lamp and is configured to acquire point group data indicating a surrounding environment of the vehicle; a lamp cleaner configured to remove dirt adhering to the outer cover; and a lamp cleaner control unit configured to acquire reflective light intensity information related to intensities of a plurality of pieces of reflective light reflected by a road surface after being emitted from the LiDAR unit, determine whether dirt adheres to the outer cover based on the acquired reflective light intensity information, and drive the lamp cleaner in response to a determination that dirt adheres to the outer cover.

According to the above-described configuration, it is determined whether dirt adheres to the outer cover based on the reflective light intensity information, and then the lamp cleaner is driven in response to the determination that dirt adheres to the outer cover. In this way, the dirt adhering to the outer cover can be detected based on the reflective light intensity information. In this regard, when dirt such as rain, snow, mud, or the like adheres to the outer cover, the intensity of the reflective light decreases due to the dirt. Therefore, the dirt adhering to the outer cover can be detected based on the intensity of the reflective light.

Accordingly, since it is possible to reliably detect the dirt adhering to the outer cover, it is possible to prevent a decrease in the detection accuracy of a sensor such as the LiDAR unit provided in the vehicle lamp.

The lamp cleaner control unit may be configured to determine, based on a comparison between the acquired reflective light intensity information and a predetermined threshold value, whether dirt adheres to the outer cover.

According to the above-described configuration, the dirt adhering to the outer cover can be detected based on the comparison between the acquired reflective light intensity information and the predetermined threshold value.

The lamp cleaner control unit may be configured to determine whether dirt adheres to the outer cover based on a comparison between each of the intensities of the plurality of pieces of reflective light and the predetermined threshold value.

According to the above-described configuration, the dirt adhering to the outer cover can be detected based on the comparison between each of the intensities of the plurality of pieces of reflective light and the predetermined threshold value.

The lamp cleaner control unit may be configured to determine whether dirt adheres to the outer cover based on a comparison between an average value or a median value of the intensities of the plurality of pieces of reflective light and the predetermined threshold value.

According to the above-described configuration, the dirt adhering to the outer cover can be detected based on the comparison between the average value or the median value of the intensities of the plurality of pieces of reflective light and the predetermined threshold value.

The predetermined threshold value may be associated with the intensity of the reflective light from a road surface measured when no dirt adheres to the outer cover.

According to the above-described configuration, since the predetermined threshold value is associated with the intensity of the reflective light from the road surface measured when no dirt adheres to the outer cover, the dirt adhering to the outer cover can be detected based on the comparison between the acquired reflective light intensity information and the predetermined threshold value.

The lamp cleaner control unit may be configured to acquire and store the reflective light intensity information when the vehicle is parked.

The lamp cleaner control unit may be configured to determine, based on a comparison between the newly acquired reflective light intensity information and the stored reflective light intensity information, whether dirt adheres to the outer cover.

According to the above-described configuration, the dirt adhering to the outer cover can be detected based on the comparison between the newly acquired reflective light intensity information and the reflective light intensity information acquired when the vehicle is parked last time.

The lamp cleaner control unit may be configured to determine, based on the acquired reflective light intensity information, whether dirt adheres to the outer cover when the road surface is dry.

A vehicle including the sensing system for a vehicle is provided.

According to the above, it is possible to provide a vehicle capable of preventing a decrease in detection accuracy of a sensor provided in a vehicle lamp.

According to the present disclosure, it is possible to provide a sensing system for a vehicle and a vehicle that are capable of preventing a decrease in detection accuracy of a sensor provided in a vehicle lamp.

### BRIEF DESCRIPTION OF DRAWINGS

FIG. 1 is a schematic view showing a vehicle provided with a vehicle system according to an embodiment (hereinafter referred to as the present embodiment) of the present invention.

FIG. 2 is a block diagram showing the vehicle system according to the present embodiment.

FIG. 3 is a block diagram showing a left front sensing system.

FIG. 4 is a flowchart showing a method for detecting dirt adhering to an outer cover according to a first embodiment.

FIG. 5 is a diagram showing laser light emitted from a LiDAR unit at each of a plurality of vertical angles.

FIG. 6 is a table showing an example of a comparison result between an intensity Iₙ of n-th reflective light and a threshold value Iₜₕ.

FIG. 7 is a flowchart showing a series of processing for acquiring reflective light intensity information when the vehicle is parked.

FIG. 8 is a flowchart showing a method for detecting dirt adhering to an outer cover according to a second embodiment.

FIG. 9 is a table showing an example of a comparison result between the intensity Iₙ of the n-th reflective light measured this time and an intensity I_{ref_n} of the n-th reflective light measured last time.

### DESCRIPTION OF EMBODIMENTS

Hereinafter, an embodiment of the present disclosure (hereinafter, simply referred to as the present embodiment) will be described with reference to the drawings. Members having the same reference numerals as members that have been described in the description of the present embodiment will be omitted for convenience of description. Dimensions of members shown in the drawings may be different from actual dimensions of the members for convenience of description.

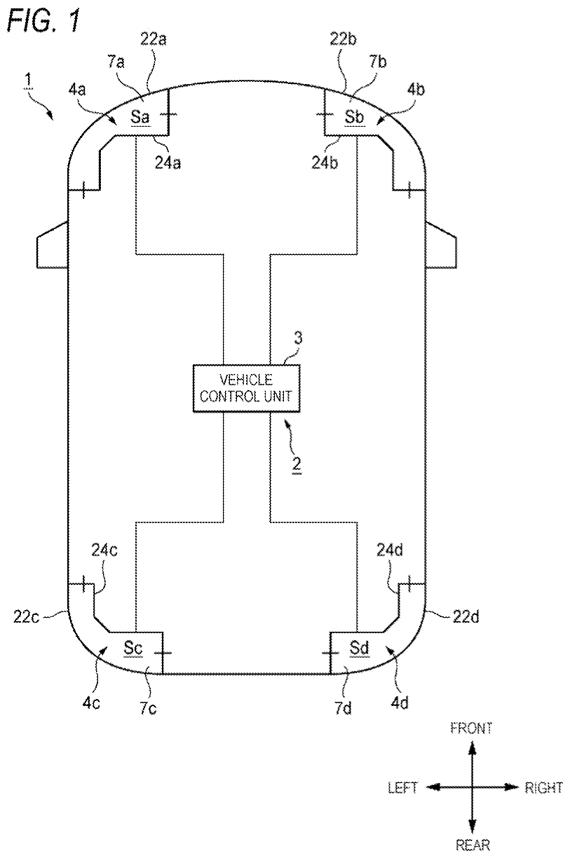

In the description of the present embodiment, for convenience of description, a “left-right direction”, a “front-rear direction”, and an “upper-lower direction” may be referred to as appropriate. These directions are relative directions set for a vehicle 1 shown in FIG. 1. Here, the “front-rear direction” is a direction including a “front direction” and a “rear direction”. The “left-right direction” is a direction including a “left direction” and a “right direction”. The “upper-lower direction” is a direction including an “upper direction” and a “lower direction”. Although not shown in FIG. 1, the upper-lower direction is a direction orthogonal to the front-rear direction and the left-right direction.

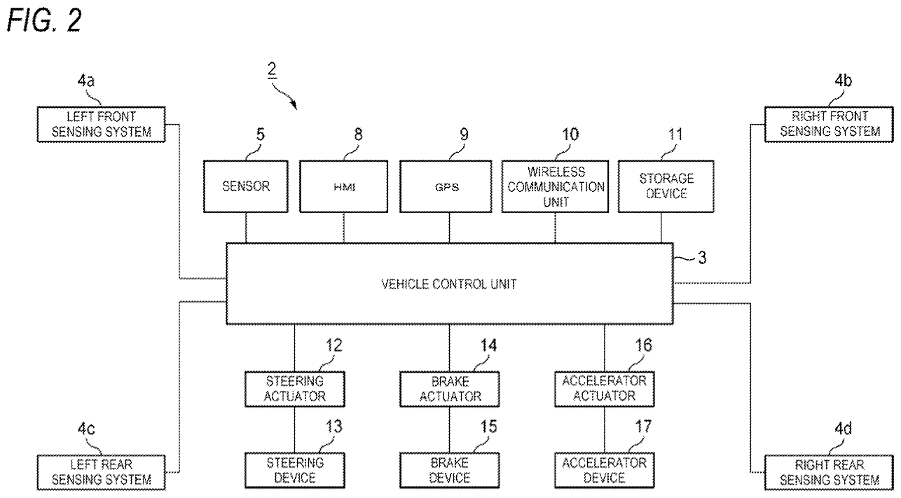

First, the vehicle 1 and a vehicle system 2 according to the present embodiment will be described with reference to FIGS. 1 and 2. FIG. 1 is a schematic view showing a top view of the vehicle 1 provided with the vehicle system 2. FIG. 2 is a block diagram showing the vehicle system 2.

As shown in FIG. 1, the vehicle 1 is a vehicle (an automobile) capable of traveling in an automatic driving mode, and includes the vehicle system 2, a left front lamp 7a, a right front lamp 7b, a left rear lamp 7c, and a right rear lamp 7d.

As shown in FIGS. 1 and 2, the vehicle system 2 includes at least a vehicle control unit 3, a left front sensing system 4a (hereinafter, simply referred to as a “sensing system 4a”), a right front sensing system 4b (hereinafter, simply referred to as a “sensing system 4b”), a left rear sensing system 4c (hereinafter, simply referred to as a “sensing system 4c”), and a right rear sensing system 4d (hereinafter, simply referred to as a “sensing system 4d”).

The vehicle system 2 further includes a sensor 5, a human machine interface (HMI) 8, a global positioning system (GPS) 9, a wireless communication unit 10, and a storage device 11. The vehicle system 2 further includes a steering actuator 12, a steering device 13, a brake actuator 14, a brake device 15, an accelerator actuator 16, and an accelerator device 17.

The vehicle control unit 3 is configured to control traveling of the vehicle 1. The vehicle control unit 3 includes, for example, at least one electronic control unit (ECU). The electronic control unit includes a computer system (for example, a system on a chip (SoC)) including one or more processors and one or more memories, and an electronic circuit including an active element such as a transistor and a passive element. The processor includes, for example, at least one of a central processing unit (CPU), a micro processing unit (MPU), a graphics processing unit (GPU), and a tensor processing unit (TPU). The CPU may include a plurality of CPU cores. The GPU may include a plurality of GPU cores. The memory includes a read only memory (ROM) and a random access memory (RAM). The ROM may store a vehicle control program. For example, the vehicle control program may include an artificial intelligence (AI) program for automatic driving. The AI program is a program (a learned model) constructed by supervised or unsupervised machine learning (in particular, deep learning) using a multi-layer neural network. The RAM may temporarily store a vehicle control program, vehicle control data, and/or surrounding environment information indicating a surrounding environment of the vehicle. The processor may be configured to load a program that is designated from various vehicle control programs stored in the ROM onto the RAM and execute various types of processing in cooperation with the RAM. The computer system may be a non-von Neumann computer such as an application specific integrated circuit (ASIC) or a field-programmable gate array (FPGA). Further, the computer system may be a combination of a von Neumann computer and a non-von Neumann computer.

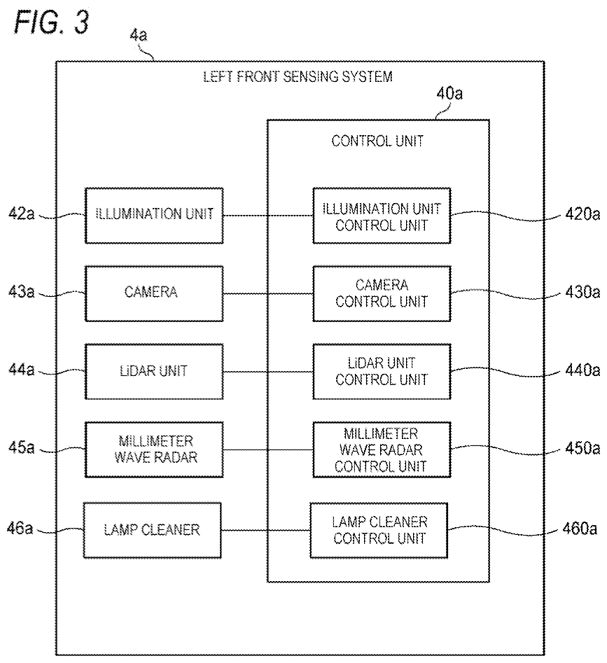

Each of the sensing systems 4a to 4d is configured to detect a surrounding environment of the vehicle 1. In the description of the present embodiment, it is assumed that each of the sensing systems 4a to 4d includes the same component. Therefore, the sensing system 4a will be described below with reference to FIG. 3. FIG. 3 is a block diagram showing the sensing system 4a.

As shown in FIG. 3, the sensing system 4a includes a control unit 40a, an illumination unit 42a, a camera 43a, a light detection and ranging (LiDAR) unit 44a (an example of a laser radar), a millimeter wave radar 45a, and a lamp cleaner 46a. The control unit 40a, the illumination unit 42a, the camera 43a, the LiDAR unit 44a, and the millimeter wave radar 45a are provided in a space Sa defined by a housing 24a of the left front lamp 7a and a translucent outer cover 22a that are shown in FIG. 1. On the other hand, the lamp cleaner 46a is provided outside the space Sa and in a vicinity of the left front lamp 7a. The control unit 40a may be provided at a predetermined position of the vehicle 1 other than the space Sa. For example, the control unit 40a may be formed integrally with the vehicle control unit 3.

The control unit 40a is configured to control operations of the illumination unit 42a, the camera 43a, the LiDAR unit 44a, the millimeter wave radar 45a, and the lamp cleaner 46a. In this regard, the control unit 40a functions as an illumination unit control unit 420a, a camera control unit 430a, a LiDAR unit control unit 440a, a millimeter wave radar control unit 450a, and a lamp cleaner control unit 460a.

The control unit 40a includes at least one electronic control unit (ECU). The electronic control unit includes a computer system (for example, an SoC) including one or more processors and one or more memories, and an electronic circuit including an active element such as a transistor and a passive element. The processor includes at least one of a CPU, an MPU, a GPU, and a TPU. The memory includes a ROM and a RAM. The computer system may be a non-von Neumann computer such as an ASIC or an FPGA.

The illumination unit 42a is configured to emit light toward an outside (a front side) of the vehicle 1 to form a light distribution pattern. The illumination unit 42a includes a light source configured to emit light and an optical system. The light source may include, for example, a plurality of light emitting elements arranged in a matrix (for example, N rows×M columns, N>1 and M>1). The light emitting element is, for example, a light emitting diode (LED), a laser diode (LD), or an organic EL element. The optical system may include at least one of a reflector configured to reflect light emitted from the light source toward a front of the illumination unit 42a, and a lens configured to refract light directly emitted from the light source or light reflected by the reflector.

The illumination unit control unit 420a is configured to control the illumination unit 42a such that the illumination unit 42a emits a predetermined light distribution pattern toward a front region of the vehicle 1. For example, the illumination unit control unit 420a may change the light distribution pattern emitted from the illumination unit 42a according to an operation mode of the vehicle 1.

The camera 43a is configured to detect a surrounding environment of the vehicle 1. In particular, the camera 43a is configured to acquire image data indicating the surrounding environment of the vehicle 1 and then transmit the image data to the camera control unit 430a. The camera control unit 430a may specify surrounding environment information based on the transmitted image data. Here, the surrounding environment information may include information related to an object that is present outside the vehicle 1. For example, the surrounding environment information may include information related to an attribute of an object present outside the vehicle 1 and information related to a distance, a direction and/or a position of the object with respect to the vehicle 1. The camera 43a includes, for example, an imaging element such as a charge-coupled device (CCD) or a complementary metal oxide semiconductor (MOS) (CMOS). The camera 43a may be a monocular camera or a stereo camera. When the camera 43a is a stereo camera, the control unit 40a can specify, using the parallax, a distance between the vehicle 1 and an object (for example, a pedestrian) present outside the vehicle 1 based on two or more pieces of image data acquired by the stereo camera.

The LiDAR unit 44a is configured to detect the surrounding environment of the vehicle 1. In particular, the LiDAR unit 44a is configured to acquire point group data indicating the surrounding environment of the vehicle 1 and then transmit the point group data to the LiDAR unit control unit 440a. The LiDAR unit control unit 440a may specify the surrounding environment information based on the transmitted point group data.

More specifically, the LiDAR unit 44a acquires information related to time of flight (TOF) ΔT1 of laser light (an optical pulse) at each emission angle (a horizontal angle θ and a vertical angle φ) of the laser light. The LiDAR unit 44a can acquire, based on the information related to the time of flight ΔT1 at each emission angle, information related to a distance D between the LiDAR unit 44a at each emission angle and an object present outside the vehicle 1.

The LiDAR unit 44a includes, for example, a light emitting unit configured to emit laser light, an optical deflector configured to perform scanning with the laser light in a horizontal direction and a vertical direction, an optical system such as a lens, and a light receiving unit configured to receive the laser light reflected by an object. A peak wavelength of the laser light emitted from the light emitting unit is not particularly limited. For example, the laser light may be invisible light (infrared light) having a peak wavelength of approximately 900 nm. The light emitting unit is, for example, a laser diode. The light deflector is, for example, a micro electro mechanical systems (MEMS) mirror or a polygon mirror. The light receiving unit is, for example, a photodiode. The LIDAR unit 44a may acquire the point group data without performing scanning with the laser light by the light deflector. For example, the LiDAR unit 44a may acquire the point group data based on a phased array method or a flash method. The LiDAR unit 44a may acquire the point group data by mechanically rotating and driving the light emitting unit and the light receiving unit.

The millimeter wave radar 45a is configured to detect radar data indicating the surrounding environment of the vehicle 1. In particular, the millimeter wave radar 45a is configured to acquire the radar data and then transmit the radar data to the millimeter wave radar control unit 450a. The millimeter wave radar control unit 450a is configured to acquire surrounding environment information based on the radar data. The surrounding environment information may include information related to an object that is present outside the vehicle 1. The surrounding environment information may include, for example, information related to the position and the direction of the object with respect to the vehicle 1 and information related to a relative speed of the object with respect to the vehicle 1.

For example, the millimeter wave radar 45a can acquire a distance between the millimeter wave radar 45a and the object present outside the vehicle 1 and a direction using a pulse modulation method, a frequency modulated continuous wave (FM-CW) method, or a two-frequency CW method. When the pulse modulation method is used, the millimeter wave radar 45a can acquire information related to time of flight ΔT2 of a millimeter wave, and then acquire information related to a distance D between the millimeter wave radar 45a and the object present outside the vehicle 1 based on the information related to the time of flight ΔT2. The millimeter wave radar 45a can acquire information related to the direction of the object with respect to the vehicle 1 based on a phase difference between a phase of the millimeter wave (the received wave) received by one reception antenna and a phase of the millimeter wave (the received wave) received by another reception antenna adjacent to the one reception antenna. The millimeter wave radar 45a can acquire information related to a relative speed V of the object with respect to the millimeter wave radar 45a based on a frequency f0 of a transmitted wave emitted from a transmission antenna and a frequency f1 of a received wave received by a reception antenna.

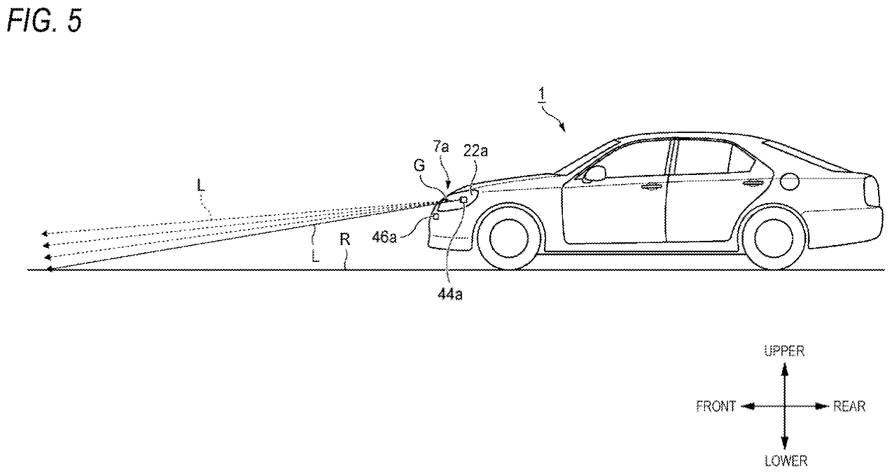

The lamp cleaner 46a is configured to remove dirt adhering to the outer cover 22a, and is provided in a vicinity of the outer cover 22a (see FIG. 5). The lamp cleaner 46a may be configured to remove dirt adhering to the outer cover 22a by injecting a cleaning liquid or air toward the outer cover 22a.

The lamp cleaner control unit 460a is configured to control the lamp cleaner 46a. The lamp cleaner control unit 460a is configured to determine whether dirt (for example, rain, snow, mud, and dust) adheres to the outer cover 22a based on reflective light intensity information related to intensities of a plurality of pieces of reflective light. The plurality of pieces of reflective light are reflected by a road surface after being emitted from the LiDAR unit 44a. Further, the lamp cleaner control unit 460a is configured to drive the lamp cleaner 46a in response to a determination that dirt adheres to the outer cover 22a.

Similarly, each of the sensing systems 4b to 4d includes a control unit, an illumination unit, a camera, a LiDAR unit, a millimeter wave radar, and a lamp cleaner. In particular, these devices of the sensing system 4b are provided in a space Sb defined by a housing 24b of the right front lamp 7b and a translucent outer cover 22b that are shown in FIG. 1. These devices of the sensing system 4c are provided in a space Sc defined by a housing 24c of the left rear lamp 7c and a translucent outer cover 22c. These devices of the sensing system 4d are provided in a space Sd defined by a housing 24d of the right rear lamp 7d and a translucent outer cover 22d.

Returning to FIG. 2, the sensor 5 may include an acceleration sensor, a speed sensor, a gyro sensor, and the like. The sensor 5 is configured to detect a traveling state of the vehicle 1 and output traveling state information indicating the traveling state of the vehicle 1 to the vehicle control unit 3. The sensor 5 may include an outside air temperature sensor configured to detect an outside air temperature outside the vehicle 1.

An HMI 8 includes an input unit configured to receive an input operation from a driver, and an output unit configured to output traveling information and the like to the driver. The input unit includes a steering wheel, an accelerator pedal, a brake pedal, a driving mode switching switch configured to switch a driving mode of the vehicle 1, and the like. The output unit is a display (for example, a head up display (HUD)) configured to display various types of traveling information. A GPS 9 is configured to acquire current position information of the vehicle 1 and output the acquired current position information to the vehicle control unit 3.

The wireless communication unit 10 is configured to receive information related to other vehicles around the vehicle 1 from the other vehicles and transmit information related to the vehicle 1 to the other vehicles (vehicle-to-vehicle communication). The wireless communication unit 10 is configured to receive infrastructure information from infrastructure equipment such as a traffic light or a sign lamp and transmit the traveling information of the vehicle 1 to the infrastructure equipment (road-to-vehicle communication). The wireless communication unit 10 is configured to receive information related to a pedestrian from a portable electronic device (a smart phone, a tablet, a wearable device, or the like) carried by the pedestrian and transmit the own vehicle traveling information of the vehicle 1 to the portable electronic device (pedestrian-to-vehicle communication). The vehicle 1 may directly communicate with the other vehicles, the infrastructure equipment, or the portable electronic device in an ad-hoc mode, or may execute communication via a communication network such as the Internet.

The storage device 11 is an external storage device such as a hard disk drive (HDD) or a solid state drive (SSD). The storage device 11 may store two-dimensional or three-dimensional map information and/or a vehicle control program. For example, the three-dimensional map information may be 3D mapping data (point group data). The storage device 11 is configured to output the map information and the vehicle control program to the vehicle control unit 3 in response to a request from the vehicle control unit 3. The map information and the vehicle control program may be updated via the wireless communication unit 10 and the communication network.

When the vehicle 1 travels in the automatic driving mode, the vehicle control unit 3 automatically generates at least one of a steering control signal, an accelerator control signal, and a brake control signal based on the traveling state information, the surrounding environment information, the current position information, the map information, and the like. The steering actuator 12 is configured to receive the steering control signal from the vehicle control unit 3 and control the steering device 13 based on the received steering control signal. The brake actuator 14 is configured to receive the brake control signal from the vehicle control unit 3 and control the brake device 15 based on the received brake control signal. The accelerator actuator 16 is configured to receive the accelerator control signal from the vehicle control unit 3 and control the accelerator device 17 based on the received accelerator control signal. In this way, the vehicle control unit 3 is configured to automatically control traveling of the vehicle 1 based on the traveling state information, the surrounding environment information, the current position information, the map information, and the like. That is, in the automatic driving mode, the traveling of the vehicle 1 is automatically controlled by the vehicle system 2.

On the other hand, when the vehicle 1 travels in a manual driving mode, the vehicle control unit 3 generates the steering control signal, the accelerator control signal, and the brake control signal according to a manual operation of the driver on the accelerator pedal, the brake pedal, and the steering wheel. In this way, in the manual driving mode, since the steering control signal, the accelerator control signal, and the brake control signal are generated by the manual operation of the driver, the traveling of the vehicle 1 is controlled by the driver.

Next, the driving mode of the vehicle 1 will be described. The driving mode includes the automatic driving mode and the manual driving mode. The automatic driving mode includes a fully automatic driving mode, a highly driving support mode, and a driving support mode. In the fully automatic driving mode, the vehicle system 2 automatically executes all kinds of traveling control including steering control, brake control, and accelerator control, and the driver cannot drive the vehicle 1. In the highly driving support mode, the vehicle system 2 automatically executes all kinds of traveling control including the steering control, the brake control, and the accelerator control, and the driver can drive the vehicle 1 but does not drive the vehicle 1. In the driving support mode, the vehicle system 2 automatically executes a part of traveling control including the steering control, the brake control, and the accelerator control, and the driver drives the vehicle 1 under driving support of the vehicle system 2. On the other hand, in the manual driving mode, the vehicle system 2 does not automatically execute the traveling control, and the driver drives the vehicle 1 without the driving support of the vehicle system 2.

(Dirt Detection Method According to First Embodiment)

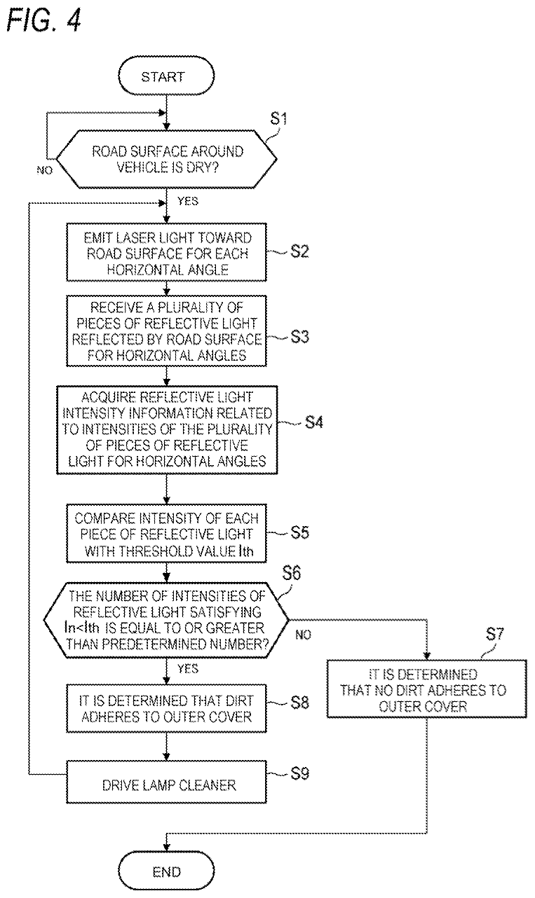

Next, a method of detecting dirt adhering to the outer cover 22a of the left front lamp 7a will be mainly described below with reference to FIG. 4. FIG. 4 is a flowchart showing a method (hereinafter, referred to as a “dirt detection method”) for detecting dirt adhering to the outer cover 22a according to the first embodiment. Only dirt detection processing executed by the sensing system 6a will be described in the present embodiment. However, it should be noted that dirt detection processing executed by the sensing systems 6b to 6d is the same as the dirt detection processing executed by the sensing system 6a.

As shown in FIG. 4, in step S1, the vehicle control unit 3 determines, based on the surrounding environment information transmitted from the sensing systems 4a to 4d, whether the road surface around the vehicle 1 is dry. When a determination result of step S1 is NO, the present determination processing is repeatedly executed until the determination result of step S1 is YES. For example, when the vehicle 1 is traveling, since the road surface around the vehicle 1 sequentially changes, the processing in step S1 may be executed until it is determined that the road surface around the vehicle 1 is dry. On the other hand, when the determination result of step S1 is YES, the present processing proceeds to step S2.

Next, in step S2, the LiDAR unit control unit 440a controls the LiDAR unit 44a such that the LiDAR unit 44a emits laser light L toward a road surface R for each horizontal angle θ (see FIG. 5). As described above, the LiDAR unit 44a is configured to emit the laser light at a plurality of emission angles including the horizontal angle θ in the horizontal direction and the vertical angle φ in the vertical direction. In this way, information related to the flight time ΔT at each emission angle is acquired, so that point group data indicating a distance for each emission angle is generated. In the dirt detection processing according to the present embodiment, the LiDAR unit 44a emits the laser light at a predetermined layer (a predetermined vertical angle φ₀) for measuring the road surface R. Here, as shown in FIG. 5, the predetermined layer corresponds to a layer of the laser light L indicated by a solid line. That is, the vertical angle φ₀ of the laser light is fixed to a predetermined vertical angle for scanning the road surface R. On the other hand, the horizontal angle θ of the laser light changes. Specifically, when an angle range in the horizontal direction is 45° and an angle pitch Δθ in the horizontal direction is 0.2°, the LiDAR unit 44a emits the laser light toward the road surface R for each of 226 horizontal angles θ. Here, when a horizontal angle of the laser light emitted at the n-th (n is an integer and 1≤n≤226) is θₙ, and a horizontal angle of the laser light emitted at the (n−1)-th is θₙ₋₁, relation of θₙ=θₙ₋₁+Δθ is established. Here, Δθ is set to 0.2° as described above.

The intensity of the laser light emitted from the LiDAR unit 44a in the processing in step S2 may be larger than the intensity of the laser light emitted from the LiDAR unit 44a when the point group data is acquired. In this regard, in the present dirt detection method, since the information related to an intensity of the reflective light reflected by the object is acquired instead of the information related to the distance of the object, it is preferable that the intensity of the laser light emitted from the LiDAR unit 44a is larger than an intensity of normal laser light in order to improve accuracy of the information related to the intensity of the laser light. Further, light receiving sensitivity of the light receiving unit for the reflective light in the processing in step S2 may be larger than light receiving sensitivity of the light receiving unit for the reflective light when the point group data is acquired.

Next, in step S3, the LiDAR unit 44a receives the reflective light reflected by the road surface R at each of the 226 horizontal angles θ (θ₁, θ₂ . . . , θ₂₂₆). After that, the LiDAR unit 44a generates reflective light intensity information related to an intensity Iₙ of the plurality of pieces of reflective light for the horizontal angles θₙ, and then transmits the generated reflective light intensity information to the lamp cleaner control unit 460a via the LiDAR unit control unit 440a. In this way, in step S4, the lamp cleaner control unit 460a acquires the reflective light intensity information from the LiDAR unit 44a. Here, the reflective light intensity information includes information related to the intensity Iₙ of the reflective light of the laser light emitted at the n-th (n=1 to 226).

Next, in step S5, the lamp cleaner control unit 460a compares each of the intensities Iₙ of 226 pieces of reflective light with a predetermined threshold value Iₜₕ. Specifically, the lamp cleaner control unit 460a determines whether each of the intensities Iₙ of the 226 pieces of reflective light is smaller than the predetermined threshold value Iₜₕ (Iₙ<Iₜₕ). Here, the predetermined threshold value Iₜₕ is associated with the intensity I of the reflective light from the road surface R measured when no dirt adheres to the outer cover 22a. For example, the predetermined threshold value Iₜₕ may be set to a value of X % of the intensity I of the reflective light from the road surface R measured when no dirt adheres to the outer cover 22a. Here, X is preferably set to a value from 40 to 70 (preferably a value from 60 to 70). However, the value of X is not particularly limited. That is, the predetermined threshold value Iₜₕ is not particularly limited. The predetermined threshold value Iₜₕ is stored in advance in a memory of the control unit 40a. The predetermined threshold value Iₜₕ may be updated with the passage of time in consideration of aging deterioration of the outer cover 22a and the like.

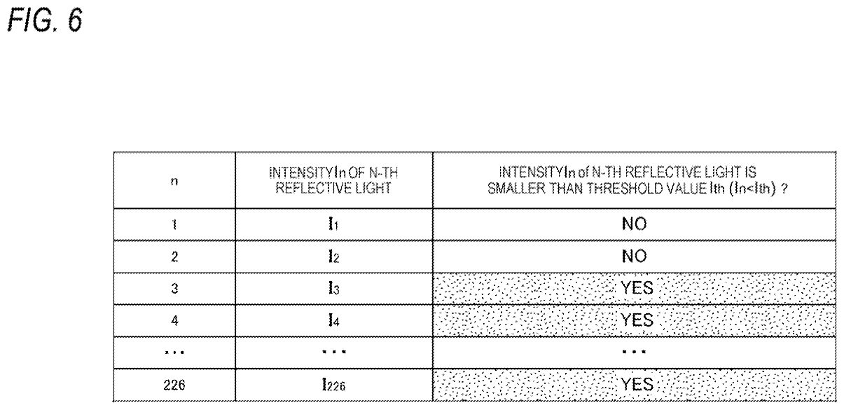

Next, through the processing in step S5, the lamp cleaner control unit 460a determines whether the number of intensities Iₙ of the reflective light smaller than the predetermined threshold value Iₜₕ is equal to or greater than a predetermined number (step S6). As shown in FIG. 6, the lamp cleaner control unit 460a determines whether each of the intensities I₁ to I₂₂₆ of the reflective light is smaller than the threshold value Iₜₕ, and then counts the number of the intensities Iₙ of the reflective light smaller than the threshold value Iₜₕ. After that, it is determined whether the counted number of intensities Iₙ of the reflective light is equal to or greater than the predetermined number.

When a determination result of step S6 is YES, the lamp cleaner control unit 460a determines that dirt G (see FIG. 5) adheres to the outer cover 22a (step S8). Here, the dirt G is, for example, rain, snow, mud, or dust. On the other hand, when the determination result of step S6 is NO, the lamp cleaner control unit 460a determines that no dirt G adheres to the outer cover 22a (step S7), and then ends the present processing.

After that, in step S9, the lamp cleaner control unit 460a drives the lamp cleaner 46a in order to remove the dirt G adhering to the outer cover 22a. Specifically, the lamp cleaner control unit 460a drives the lamp cleaner 46a such that a cleaning liquid or air is injected from the lamp cleaner 46a toward the outer cover 22a.

After the lamp cleaner 46a performs dirt removing processing on the outer cover 22a (after the processing in step S9 is performed), the present processing returns to step S2. In this way, the processing from step S2 to step S9 is repeatedly performed until it is determined that no dirt G adheres to the outer cover 22a. The present processing may be terminated after the processing in step S9 is performed.

In this way, according to the present embodiment, it is determined based on the reflective light intensity information related to the intensity Iₙ of the plurality of pieces of reflective light whether dirt adheres to the outer cover 22a, and then the outer cover 22a is driven according to the determination that dirt adheres to the outer cover 22a. In this way, the dirt adhering to the outer cover 22a can be detected based on the reflective light intensity information. In this regard, when dirt such as rain, snow, mud, or the like adheres to the outer cover 22a, the intensity of the reflective light decreases due to the dirt. Therefore, the dirt adhering to the outer cover 22a can be detected based on the intensity of the reflective light. In particular, experimental results at this time have shown that the intensity of the reflective light when dirt adheres to the outer cover 22a is a value from 60% to 70% of the intensity I of the reflective light from the road surface R measured when no dirt adheres to the outer cover 22a. Therefore, since it is possible to reliably detect the dirt adhered to the outer cover 22a, it is possible to prevent a decrease in the detection accuracy of the sensor such as the LiDAR unit 44a provided in the left front lamp 7a.

According to the present embodiment, as described in the processing in step S1, when the road surface R around the vehicle 1 is dry, the processing (in other words, the dirt detection processing) in step S2 to step S9 is executed. In this regard, when the road surface R is wet, the laser light emitted from the LiDAR unit 44a is specularly reflected by the road surface R. Therefore, since the intensity of the light incident on the light receiving unit of the LiDAR unit 44a after being reflected by the road surface R is fairly small, it may not be possible to determine with high accuracy whether dirt adheres to the outer cover 22a based on the reflective light intensity information. On the other hand, according to the present embodiment, since the processing of determining whether dirt adheres to the outer cover 22a is executed when the road surface R is dry, it is possible to determine with high accuracy whether dirt adheres to the outer cover 22a based on the reflective light intensity information.

In the present embodiment, in the comparison processing in step S5, it is determined whether each of the intensities Iₙ of the 226 pieces of reflective light is smaller than the predetermined threshold value Iₜₕ. However, the comparison processing in step S5 is not particularly limited. For example, it may be determined whether an average value or a median value of the intensities Iₙ of the 226 pieces of reflective light is smaller than the predetermined threshold value Iₜh. When it is determined that the average value or the median value of the intensities Iₙ of the reflective light is equal to or greater than the predetermined threshold value Iₜₕ, in step S7, the lamp cleaner control unit 460a may determine that no dirt G adheres to the outer cover 22a. On the other hand, when it is determined that the average value or the median value of the intensities Iₙ of the reflective light is smaller than the predetermined threshold value Iₜₕ, in step S8, the lamp cleaner control unit 460a may determine that the dirt G adheres to the outer cover 22a. In this case, it should be noted that the processing in step S6 is omitted.

In the present embodiment, the angle range and the angle pitch of the LiDAR unit 44a in the horizontal direction are set to 45° and 0.2°, respectively. However, the present embodiment is not limited thereto. The value of the angle range and the angle pitch of the LiDAR unit 44a in the horizontal direction may be any value.

(Dirt Detection Method According to Second Embodiment)

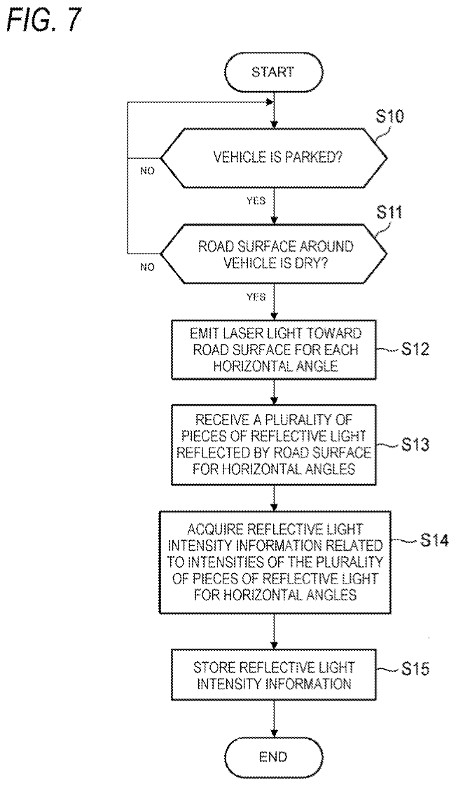

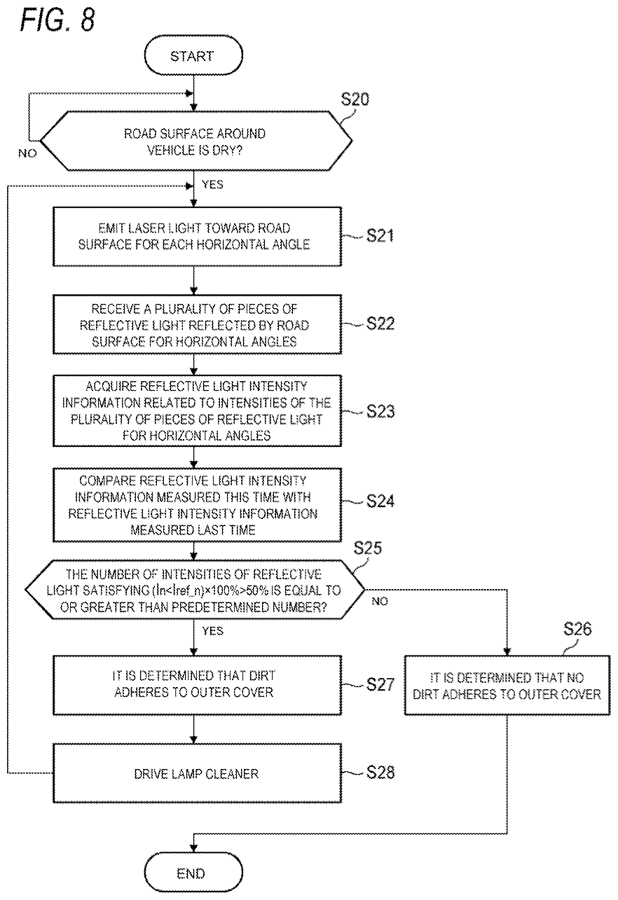

Next, a method of detecting dirt adhering to the outer cover 22a of the left front lamp 7a according to a second embodiment will be mainly described below with reference to FIGS. 7 and 8. FIG. 7 is a flowchart showing a series of processing for acquiring reflective light intensity information when the vehicle 1 is parked. FIG. 8 is a flowchart showing a method (dirt detection method) for detecting dirt adhering to the outer cover 22a according to the second embodiment. Similarly, only dirt detection processing executed by the sensing system 6a will be described in the present embodiment. However, it should be noted that dirt detection processing executed by the sensing systems 6b to 6d is the same as the dirt detection processing executed by the sensing system 6a.

First, a series of processing for acquiring the reflective light intensity information when the vehicle 1 is parked will be described below with reference to FIG. 7. As shown in FIG. 7, in step S10, when the vehicle 1 is parked (YES in step S10), the vehicle control unit 3 determines, based on surrounding environment information transmitted from the sensing systems 4a to 4d, whether a road surface around the vehicle 1 is dry (step S11). When a determination result of step S10, S11 is NO, the present determination processing is repeatedly executed until the determination result of step S10, S11 is YES. On the other hand, when the determination result of step S11 is YES, the present processing proceeds to step S12. When the vehicle 1 is traveling in a highly automatic driving mode or a fully automatic driving mode, the vehicle control unit 3 may determine to park the vehicle 1. In this case, after the vehicle control unit 3 determines to park the vehicle 1, the processing in step S11 and the subsequent steps is executed. On the other hand, when the vehicle 1 is traveling in a manual driving mode or a driving support mode, the vehicle control unit 3 may determine whether the vehicle 1 is currently parked based on the surrounding environment information (for example, presence of a parking lot) and traveling information (for example, back traveling) of the vehicle 1.

Next, in step S12, the LiDAR unit control unit 440a controls the LiDAR unit 44a such that the LiDAR unit 44a emits the laser light L toward the road surface R for each horizontal angle θ (see FIG. 5). Next, in step S13, the LiDAR unit 44a receives the reflective light reflected by the road surface R at each of the 226 horizontal angles θ (θ₁, θ₂ . . . , θ₂₂₆). After that, the LiDAR unit 44a generates reflective light intensity information related to the intensity Iₙ of the plurality of pieces of reflective light for the horizontal angles θₙ, and then transmits the generated reflective light intensity information to the lamp cleaner control unit 460a via the LiDAR unit control unit 440a. In this way, the lamp cleaner control unit 460a can acquire the reflective light intensity information (step S14). After that, the lamp cleaner control unit 460a stores the acquired reflective light intensity information in the memory of the control unit 40a or the storage device 11 (see FIG. 2) (step S15). In this way, the reflective light intensity information measured when the vehicle 1 is parked is stored in the vehicle 1.

Next, the dirt detection method according to the second embodiment will be described below with reference to FIG. 8. The dirt detection method shown in FIG. 8 is executed, for example, when the vehicle 1 stored in the parking lot is activated. As shown in FIG. 8, in step S20, the vehicle control unit 3 determines, based on the surrounding environment information transmitted from the sensing systems 4a to 4d, whether the road surface around the vehicle 1 is dry. When a determination result of step S20 is YES, the present processing proceeds to step S21. On the other hand, when the determination result of step S20 is NO, the determination processing in step S20 is repeatedly executed.

Next, in step S21, the LiDAR unit control unit 440a controls the LiDAR unit 44a such that the LiDAR unit 44a emits the laser light L toward the road surface R for each horizontal angle θ.

Next, in step S22, the LiDAR unit 44a receives the reflective light reflected by the road surface R at each of the 226 horizontal angles θ (θ₁, θ₂ . . . , θ₂₂₆). After that, the LiDAR unit 44a generates reflective light intensity information related to the intensity Iₙ of the plurality of pieces of reflective light for the horizontal angles θₙ, and then transmits the generated reflective light intensity information to the lamp cleaner control unit 460a via the LiDAR unit control unit 440a. In this way, in step S23, the lamp cleaner control unit 460a acquires the reflective light intensity information from the LiDAR unit 44a.

Next, in step S24, the lamp cleaner control unit 460a compares the reflective light intensity information measured this time with the reflective light intensity information that is measured last time and is stored in the vehicle 1. In this regard, the lamp cleaner control unit 460a compares each of the intensities Iₙ of the 226 pieces of reflective light measured this time with a corresponding one of the intensities I_{ref_n} of the 226 pieces of reflective light measured last time. Specifically, the lamp cleaner control unit 460a determines whether a ratio (a percentage) of the intensity Iₙ of the n-th reflective light measured this time to the intensity I_{ref_n} of the n-th reflective light measured last time is less than 50% (n=1, . . . 226). That is, the intensity Iₙ of the reflective light and the intensity I_{ref_n} of the reflective light are compared based on the following expression (1).

(Iₙ/I_{ref_n})×100%<50% (1)

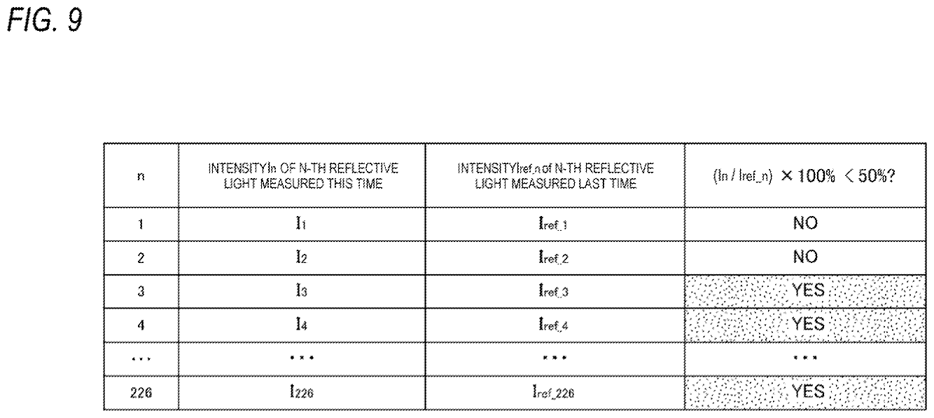

After that, the lamp cleaner control unit 460a determines whether the number of intensities Iₙ of the reflective light satisfying the above expression (1) is equal to or greater than a predetermined number (step S25). As shown in FIG. 9, the lamp cleaner control unit 460a compares each of intensities I₁ to I₂₂₆ of the reflective light with a corresponding one of intensities I_{ref_1} to I_{ref_226} of the reflective light, so that the number of the intensities Iₙ of the reflective light satisfying the expression (1) is counted.

When a determination result of step S25 is YES, the lamp cleaner control unit 460a determines that the dirt G (see FIG. 5) adheres to the outer cover 22a (step S27). On the other hand, when the determination result of step S25 is NO, the lamp cleaner control unit 460a determines that no dirt G adheres to the outer cover 22a (step S26), and then ends the present processing.

After that, in step S28, the lamp cleaner control unit 460a drives the lamp cleaner 46a in order to remove the dirt G adhering to the outer cover 22a. Specifically, the lamp cleaner control unit 460a drives the lamp cleaner 46a such that a cleaning liquid or air is injected from the lamp cleaner 46a toward the outer cover 22a.

After the lamp cleaner 46a performs dirt removing processing on the outer cover 22a (after the processing in step S28 is performed), the present processing returns to step S21. In this way, the processing from step S21 to step S8 is repeatedly performed until it is determined that no dirt G adheres to the outer cover 22a. The present processing may be terminated after the processing in step S28 is performed.

In this way, according to the present embodiment, the dirt G adhering to the outer cover 22a can be detected based on the comparison between the reflective light intensity information measured last time and the reflective light intensity information measured this time. Therefore, since it is possible to reliably detect the dirt G adhered to the outer cover 22a, it is possible to prevent a decrease in the detection accuracy of the sensor such as the LiDAR unit 44a provided in the left front lamp 7a.

In the present embodiment, in the processing in steps S24 and S25, it is determined whether the ratio (the percentage) of the intensity Iₙ of the n-th reflective light measured this time to the intensity I_{ref_n} of the n-th reflective light measured last time is less than 50%, and then the number of intensities Iₙ of the reflective light satisfying the above expression (1) is counted. However, the present embodiment is not limited thereto. For example, it may be determined whether the ratio (the percentage) of the intensity Iₙ of the reflective light to the intensity I_{ref_n} of the reflective light is less than X % (here, 0%<X<100%). It may be determined whether a difference ΔIₙ between the intensity I_{ref_n} of the reflective light and the intensity Iₙ of the reflective light is equal to or less than the predetermined threshold value Iₜₕ.

The embodiments of the present invention have been described above. However, it is needless to say that the technical scope of the present invention should not be interpreted as being limited to the description of the present embodiments. It is to be understood by those skilled in the art that the present embodiments are merely an example and various modifications may be made within the scope of the invention described in the claims. The technical scope of the present invention should be determined based on the scope of the invention described in the claims and an equivalent scope thereof.

The present application appropriately incorporates the contents disclosed in Japanese Patent Application (Japanese Patent Application No. 2019-026548) filed on Feb. 18, 2019.

1. A sensing system for a vehicle configured to detect dirt adhering to an outer cover of a vehicle lamp provided in a vehicle, the sensing system for a vehicle comprising:
a LiDAR unit provided in a space defined by a housing and the outer cover of the vehicle lamp and configured to acquire point group data indicating a surrounding environment of the vehicle;
a lamp cleaner configured to remove dirt adhering to the outer cover; and
a lamp cleaner control unit configured to acquire reflective light intensity information related to intensities of a plurality of pieces of reflective light reflected by a road surface after being emitted from the LiDAR unit, determine whether dirt adheres to the outer cover based on the acquired reflective light intensity information, and drive the lamp cleaner in response to a determination that dirt adheres to the outer cover.

2. The sensing system for a vehicle according to claim 1,
wherein the lamp cleaner control unit is configured to determine, based on a comparison between the acquired reflective light intensity information and a predetermined threshold value, whether dirt adheres to the outer cover.

3. The sensing system for a vehicle according to claim 2,
wherein the lamp cleaner control unit is configured to determine whether dirt adheres to the outer cover based on a comparison between each of the intensities of the plurality of pieces of reflective light and the predetermined threshold value.

4. The sensing system for a vehicle according to claim 2,
wherein the lamp cleaner control unit is configured to determine whether dirt adheres to the outer cover based on a comparison between an average value or a median value of the intensities of the plurality of pieces of reflective light and the predetermined threshold value.

5. The sensing system for a vehicle according to claim 2,
wherein the predetermined threshold value is associated with the intensity of the reflective light from a road surface measured when no dirt adheres to the outer cover.

6. The sensing system for a vehicle according to claim 1,
wherein the lamp cleaner control unit is configured to acquire and store the reflective light intensity information when the vehicle is parked, and
wherein the lamp cleaner control unit is configured to determine, based on a comparison between the newly acquired reflective light intensity information and the stored reflective light intensity information, whether dirt adheres to the outer cover.

7. The sensing system for a vehicle according claim 1,
wherein the lamp cleaner control unit is configured to determine, based on the acquired reflective light intensity information, whether dirt adheres to the outer cover when the road surface is dry.

8. A vehicle comprising the sensing system for a vehicle according claim 1.
